(19) United States
(12) Patent Application Publication
(10) Pub. No.: US 2009/0261057 A1
(43) Pub. Date: Oct. 22, 2009

(54) Closure with Barrier Liner

(76) Inventors: Rodney Druitt, Cheltenham (GB); Louis Lagler, Stafa (CH)

Correspondence Address: PAULEY PETERSEN & ERICKSON, 2800 WEST HIGGINS ROAD, SUITE 365, HOFFMAN ESTATES, IL, 60169, US

(21) Appl. No.: 11/991,968

(22) PCT Filed: Sep. 11, 2006
(86) PCT No.: PCT/EP06/66239

§ 371 Date: Dec. 23, 2008

Related U.S. Application Data
(60) Provisional application No. 60/716,418, filed on Sep. 12, 2005.

(51) Int. Cl. B65D 53/00; B28B 5/06

(52) U.S. Cl. 215/341; 264/255

(57) ABSTRACT

The present invention is directed to a closure (1) for container and a process for making of the closure (1). The closure comprises an outer shell (2), a sealing liner (8) and a barrier liner (12) which at least partially is encompassed by the sealing liner (8) and the outer shell (2). The sealing liner (8) comprises holding means (10, 15) to temporarily hold onto a core of an injection molding device such that the sealing liner (8) can be moved between several positions during making of the closure (1).

### FIELD OF THE INVENTION

The herein disclosed invention is directed to a closure with a barrier liner and a process for making such a closure.

### BACKGROUND OF THE INVENTION

Closures are generally manufactured as single piece closures with or without a sealing liner from several types of plastic, such as Polyethylene (from now on PE) or Polypropylene (from now on PP). The latter is used for the shell manufacture of liner closures; the material is harder and less durable than PE. Softer material such as Low density PE (LDPE), ethylene vinyl acetate (EVA), compounds based on polyolefinic raw materials or EVM-based materials such as Darex are often used as liner material. More rigid materials such as Polypropylene are often used as a shell material of closures.

For certain products for which protection from gas permeation is needed three component barrier closures are required. Plastics like HDPE and PP allow gas like oxygen and carbon dioxide to slowly transmit through the closure wall. This will affect the product detrimentally. Examples of this are set out below.

| PRODUCT | GAS | EFFECT |
|---|---|---|
| Beer | O₂ | Reduced shelf life due to colour |
| | | and flavour |
| Wine | O₂ | Reduced shelf life due to colour |
| | | and flavour |
| Fruit Juices (hot fill or aseptic) | O₂ | Reduced shelf life due to colour |
| | | and flavour |
| Carbonated Soft Drink | CO₂ | Loss of gas over time |

From the prior art barrier closures are known.

U.S. Pat. No. 4,896,782A of Hawkins et al. was published in 1990 and is directed to a closure having an insert which acts as a barrier over a container neck lip to selectively shield the product being packaged. An elastic sealing member which can be in the form of an O-ring is compressed between the insert and the container neck lip by a threaded cap of the container.

WO2003086890A1 of E. I. Du Pont de Nemours and Company was published on 23 Oct. 2003 and relates to a plastic barrier closure for bottles and the like. The closure has a body with a top wall, a side wall, a securing means and a seal that has at least one concentric sealing member extending from the top wall. A barrier layer may be incorporated into the top wall by depositing a melted mass of barrier polymer in the pre-molded cap body and then molding it into place by mechanical means. Alternatively a layer made out of barrier polymer is inserted into a pre-molded cap shell.

WO2002096645A1 of Celerier et al., was published on 5 Dec. 2002. It concerns a cap liner having a middle layer made of a plastic material with gas barrier effect. First and second outer layers, each comprise a polyolefin resin, are arranged on either side of the middle layer. An intermediate polyethylene layer is placed between the middle layer and each of the outer layers. The intermediate layers being designed to protect the middle layer against moisture and to prevent degradation of said middle layer gas barrier properties. The cap liner can be placed in a cap near its transverse wall or towards the free end of its skirt or on a container neck. It can be planar or thermoformed.

JP2004001862A provides a pilfer-proof cap with an improved gas barrier. The pilfer-proof cap comprises a shell made of a first and a packing made of a synthetic resin. The shell comprises a top board, a skirt wall and a tamper evidence band which is connected to the lower end of the skirt wall through a plurality of bridges. The packing is inserted in the shell and is equipped with a packing top board which is mounted on and bonded to the upper end surface of a container mouth part. An internal leg extends from the packing top board 15 and reaches into and is sealingly engaged with the opening of the container mouth part when the cap is closed. The packing is made of synthetic resin and includes a gas barrier material containing an ethylene-vinyl alcohol or ethylene-vinyl acetate-vinyl alcohol terpolymerized resin in the molding resin material.

JP2002059948A is directed to a solution for holding a sealing barrier in a closure. The closure comprises a top wall, a bore seal extending from the top wall and an outer skirt, made out of synthetic resin. The bore seal is a frustum of circular cone in which at least an upper part at the outer circumferential surface extends downwardly at a slant angle, with respect to an axis of the container lid, in a radial outward direction. The barrier film is being applied as an insert member in a mold cavity before synthetic resin to form the closure is poured from a central part of the outer surface of a molding cavity for forming the shielding wall.

JP2002029554A provides a plastic two-part cap in which a barrier thin film layer is formed to prevent effect of contents and effect exerted during attachment to a container main body. The two-part cap comprises a cap main body and an inner stopper which is fitted below a top plate of the cap main body. A thin film layer of ceramic is formed on at least the underside of the top plate of the cap main body or the upper side of the inner stopper.

JP2001287758A provides a double-piece cap having an odour keeping characteristic or gas barrier characteristic for stored contents. The double-piece cap comprises a cap main body and a plug. A contact ring is arranged against the top surface of the bottle opening neck. A plug is inserted below the top plate of the cap main body only by a predetermined distance in such a way that it can be moved in an upward or downward direction. The plug seams to have a bore seal and a conical outer seal extending radially inwardly.

JP2001192057A is directed to a synthetic resin cap with an improved gas barrier property. The cap comprises a shell to be screwed to a container mouth and a packing for sealing the container mouth which are both formed of a resin material. A thin layer of gas barrier material seams to be surrounded by the material forming the packing. The thin layer of gas barrier material extends across the opening to be sealed.

WO2004007296A2 of Druitt et al. was published on 22 Jan. 2004 and relates to a method and apparatus for positioning a disc, such as a barrier disc, in a closure. In particular it relates to a method and apparatus for positioning a barrier disc in a self-sealing molded plastic closure having a sealing fin arrangement for providing a seal when the closure is appropriately applied to a finish of a container. The method comprises the steps of providing a barrier disc in a position ready for insertion within the closure, pressing the barrier disc into the closure such that at least a portion of the disc is positioned adjacent the top panel thereof and applying a fluid pressure to the barrier disc such that the entire disc is forced into a position at least adjacent the top panel. The apparatus comprises an insertion station for supporting the closure through the disc positioning process and a tool that is movable relative to the insertion station to drive the disc relatively into the closure. The tool comprises a plunger adapted to press the disc into the closure such that at least a portion of the disc is adjacent the top panel thereof. Fluid travels through a flow path to apply fluid pressure to the disc and force the entire disc past the sealing fin and into a position at adjacent the top panel.

Three piece closures known from prior art comprise a barrier liner which is made separately from the shell of the closure and then implemented into the outer shell of the closure by an appropriate process. These closures have several drawbacks. Besides having only limited possibilities with respect to the design of the sealing and the tamper evidence means they further require a time consuming assembly process of multiple parts. Because the liner is often inserted as a separate part a further disadvantage consists in that the multi-piece closure tends to contaminate during assembly and storage such that additional sterilization is required which is difficult due to the multi-piece design. A further draw back is that no sufficient interconnection between the barrier liner and an outer shell, respectively a sealing means of the closure is achievable such that the closure tends to fall apart. Still a further problem consists in that due to the multi part setup or due to the reason that a sealing liner is made second the geometry of the closure often tends to be inaccurate.

### PROBLEM TO BE SOLVED

It is an object of the present invention to provide a closure with a barrier liner which can be manufactured easily and which does not need separate assembly.

It is a further object of the present invention to provide a process to make a closure with a barrier liner in a cost efficient way.

It is still a further object of the present invention to provide a closure having an integrated barrier liner which does not tend to contaminate.

It is still a further object of the present invention to provide a closure with a barrier liner providing an accurate geometry.

### SUMMARY OF THE INVENTION

In general a closure according to the present invention comprises an outer shell with a disc like top portion and a therewith adjacent, essentially cylindrical outer skirt and interlocking means such as an internal thread suitable to be engaged with the external thread of a standardized neck of a PET or glass container as known from prior art having an opening to be sealed by the closure. The outer shell is preferably made out of Polypropylene (PP) or Polyethylene (PE), in particular High Density Polyethylene (HDPE).

The closure further comprises sealing means to seal the opening of the neck of the container and a barrier liner foreseen to prevent unwanted gas permeation between the outside and the inside of the closure. The barrier liner is preferably shaped three-dimensional.

The sealing liner is made out of a sealing liner material such as PE, in particular low density polyethylene (LDPE), PP, EVA and compounds thereof such as a material known as Darex. The liner and the outer shell of the closure are preferably made out of materials which are joining due to injection molding.

The barrier liner is made, preferably by injection molding, out of a barrier liner material such as polyvinylidene chloride (PVDC). PVDC has been known since a long time under the trade name “Saran” for wrapping products in the form of resins and films. PVDC works by polymerizing vinylide chloride with monomers such as acrylic esters and unsaturated carboxyl groups, forming long chains of vinylide chloride. The copolymerization results in a film with molecules bound so tightly together that very little gas or water can get through. The result is a barrier against oxygen, moisture, chemicals and heat-qualities used to protect food, consumer and industrial products. PVDC is resistant to oxygen, water, acids, bases, and solvents. Alternatively or in addition the barrier liner may be made out of a biodegradable material such as a Plantic® of the company with the same name. Depending on the field of application and the material used the barrier liner can be made by injection molding, or by compression molding or by co-extruding or by stamping out of a sheet of material.

The outer shell, the sealing means and the barrier liner of a closure according to the present invention are normally firmly bond to each other by a single injection molding process.

If appropriate, the closure may comprise a tamper evidence band integrally interconnected to the lower end of the outer skirt of the closure, e.g. by tearable bridges. The tamper evidence band comprises interlocking means such as undercut segments arranged substantially radially inwardly to be engaged with a tamper evidence bead of the neck of a bottle creating a contact upon opening of the closure such that the tamper evidence band is detached from the outer skirt of the closure by destroying the tearable bridges. Thereby initial opening is indicated.

In a preferred embodiment the barrier liner is arranged at least partially between the outer shell of the closure and the sealing means. However, depending on the field of application and the design of the closure, part of the barrier liner may be exposed to the goods (liquids) stored inside the container and/or the environment. The sealing means are normally arranged between the neck of the container and the outer shell of the closure, respectively the barrier liner, forming in a closed position a tight interconnection.

The closure according to the present invention is preferably made by an injection molding process, in particular a two-component, respectively a three-component injection molding process, in a single multi-component mold whereby a sealing liner with or without a downward leg (bore-seal and/or outside seal) is made in that a first plastic material is injected in liquid form into a first cavity onto a core of a mold cavity where the first material forming the sealing liner congeals. The sealing liner is preferably shaped, respectively comprises holding means which guarantee that the sealing liner temporarily holds on a core such that the sealing liner can be moved with the core between several process steps. Good results have been achieved when the sealing liner has at least one downward leg which temporarily engages with the core but does not result in hindering retaining forces while demoulding.

Afterwards a barrier liner is applied at least onto a part of the back surface of the sealing liner, e.g. in that the sealing liner is moved into a second position, e.g. at an angle of 90° with respect to the first position at 0°, where a pre-made barrier liner is applied manually. Alternatively or in addition it is possible to provide a core in the mold which is displaced to form a cavity into which the material forming the barrier liner is injected. E.g. it is possible to design a back area of the cavity to form the sealing liner displaceable with respect to a front area such that a cavity for the barrier liner may be formed by moving the back area with respect to the front area by a certain distance which corresponds in general to the thickness of the barrier liner. The sealing liner thereby stays attached to either the front or the back area of the cavity. Alternatively or in addition it is possible to move the sealing liner arranged on a core from a 0° into a 90° position with respect to the first 0° position whereby in the 90° position the liner is enclosed into a cavity and then material forming the barrier liner is injected into the cavity. Depending on the design of the mold it is possible to inject at the same time, when the barrier liner is injected, material to form a further sealing liner in the cavity at 0° position.

The barrier liner is preferably shaped such that it holds on the sealing liner without external aid. This can be achieved in that the barrier liner is shaped three-dimensional such that it cooperates at least partially with and holds onto the sealing liner during making of the closure, e.g. in that the barrier liner and/or the sealing liner comprise at least one protrusion which mates with a corresponding recesses in the sealing liner and/or the barrier liner. Alternatively or in addition the barrier liner can be shaped such that it temporarily holds onto the sealing liner due to vaccum. Depending on the field of application, a further possibility is to use a certain type of adhesive or glue.

In a further step the sealing liner and the barrier liner are displaced with the first core into a third cavity position, e.g. a 180° with respect to the 0° position, wherein a further material component for an outer shell of the closure is injected into a further cavity forming at least a disc like top portion and an outer skirt of the closure. Normally, at least the material of the sealing-liner and the material of the outer shell are thereby integrally joined to each other.

To optimize the production process the area in the cavity of the sealing-liner which is not in contact with the first core is preferably shaped such that the sealing-liner can be taken out of the first cavity without unwanted retaining forces. Therefore hindering undercuts mainly extending perpendicularly with respect to the displacing direction of the core are avoided. By the described injection molding process a firm bonding may be obtained between the liner and the shell material.

The sealing liner may comprise means to position and align the barrier liner with respect to the sealing liner especially during the making of the closure. E.g. the sealing liner may comprise a downward leg which is arranged in general perpendicular with respect to the disk like top portion of the closure (in general concentric to the axis of the closure). This downward leg may comprise on the backside an annular cavity or a sequence of cavities arranged concentric to the downward leg which works as fastener means for the barrier liner which is provided as an element which is made by a separate external process or which is made by injection molding onto the sealing liner.

In a preferred embodiment the sealing liner is at least partially bond to the outer shell of the closure such that the barrier liner is fully enclosed by the sealing liner and the outer shell of the closure. This offers the opportunity to choose a material for the barrier liner which does not necessarily bond to the materials of the outer shell and the sealing liner. A further advantage is that the closure different to closures known from prior art, does not tend to contaminate and it can easily be sterilized if necessary.

In a different embodiment the barrier liner may be designed to form an intermediate layer between the sealing liner and the outer shell of the closure. However thereby it is necessary that the materials for the sealing liner, the barrier liner and the outer shell bond to each other which reduces the selection of available materials.

The sealing means of a preferred embodiment of a closure according to the present invention may comprise a downward leg with an essentially cylindrical shaped inner skirt arranged inside the outer skirt of the closure shell extending perpendicular from the annular top surface into the closure radially distanced to the outer skirt and made out of the material of the outer shell of the closure and/or the liner. The inner skirt is at its base preferably interconnected directly to the disc like top portion of the closure. Depending on the field of application the leg shaped inner skirt may be functionally or rigidly interconnected to the outer skirt of the closure. However, this may implicate that the closure is not as flexible with respect to adjusting to a radial distortion of the neck of the bottle. Inside the inner skirt a sealing liner is arranged which is formed out of the same or a different material as the outer shell of the closure. The sealing liner is preferably made out of a softer material than the outer shell of the closure.

With respect to its cross-section the sealing-liner may comprise or be adjacent to an outer downward leg extending at least partially along the inner skirt of the outer shell. The outer downward leg of the liner or the inner skirt of the outer shell may comprise at its free end an in general toroidal sealing ring which interacts in closing position of the closure on the neck of a container radially from the outside with an in general cylindrical outer free surface, arranged between the annular top surface and the start of the outside thread of the neck of the container, via a designated contact surface. The contact surface is arranged preferably as far down onto the free surface of the neck of the bottle as possible to reduce influence of deformation, e.g. doming, bottle finish damage at the upper outside rim, lifting of closure, of the closure which might occur. The toroidal sealing ring is preferably shaped such that it seals primarily due to annular tension. Therefore the toroidal sealing ring comprises an annular protrusion which is arranged in engaged position towards the neck of the container. In difference to seals known form prior art which act on the inside surface of the neck and therefore are mainly subject to annular pressure forces, the toroidal sealing of the present embodiment mainly seals due to annular tension forces. By the design of the sealing means contact and defined interaction with the outer skirt of the closure may be appropriate depending on the field of application although adjustability to radial distortion of the neck of a container is reduced.

Depending on the field of application the sealing-liner further comprises a top seal which interacts with an annular top-surface of the neck of the container and/or a bore seal which reaches into the opening of the neck of the container. In difference to the prior art the present invention offers the opportunity to develop specific undercut regions aligned with respect to the neck of the container and forming contact zones of increased interaction between the sealing means and the neck of the container. One advantage of the herein disclosed sealing means consists in the improved performance of the sealing means when applied on damaged bottle neck finishes. Especially due to the reason that the described sealing means do interact with the neck finish in areas which normally are quiet unlikely to be damaged.

In an embodiment the downward leg and/or the inner skirt comprise in the area of its lower free end at least one annular sealing ring which interacts in the closing position of the closure on the neck radially from the outside with an in general cylindrical outer free surface of the neck of the container via a designated contact surface.

In an embodiment of the invention the closure comprises an outer shell, a sealing liner and a barrier liner which at least partially is encompassed by the sealing liner and the outer shell. The sealing liner comprises holding means to temporarily hold onto a core of an injection molding device such that the sealing liner can be moved between several positions during making of the closure. That the sealing liner may comprise at least one downward leg which acts as a holding means. The downward leg may act as an outside seal. The outside seal may comprise an annular sealing ring forming in a closed position a first contact point with an outer cylindrical surface of a neck of a container to be sealed. In a preferred embodiment the outside seal blends by a blend having a radius R into a liner disc, whereby said blend forms in a closed position a further second contact point with an outer top surface of the neck. The outside seal may laterally be supported by an inner skirt of the outer shell, whereby the inner skirt is arranged essentially concentrically to the outer skirt at a distance. The sealing liner may further comprise a downward leg in form of a bore seal which sealingly interacts by a further contact point with an inner surface of the neck. The barrier liner normally is attached to the sealing liner. The barrier liner may have a 3-dimensional shape which partially encompasses the sealing liner such that the barrier liner holds onto the sealing liner. In a preferred embodiment the barrier liner is fully encompassed by the outer shell and the sealing liner. The outer shell and the sealing liner may be made out of different or the same material.

A process for making of a closure according to the present invention normally comprises the following steps:
a) Injecting of liquid sealing liner material into a cavity of an injection molding device onto a core where the sealing liner material congeals forming the sealing liner.
b) Attaching a barrier liner onto the sealing liner.
c) Injecting of liquid shell material into a cavity around the barrier liner and the sealing liner forming the outer shell of the closure.

The barrier liner may be made separated outside the injection molding device and attached to the sealing liner e.g. by a handling system. Alternatively the barrier liner is made in the injection molding device in that liquid barrier liner material is injected into a cavity whereby the sealing liner is forming part of the cavity wall. Depending on the field of application the closure may be manufactured without a barrier liner in that no barrier liner is applied. The closure may then be made with or without a sealing liner made of a different material then the outer shell. Thereby it becomes possible to make in the same injection molding device a closure with or without a barrier and/or a sealing liner.

### BRIEF DESCRIPTION OF THE DRAWINGS

The closure according to the present invention is explained in more detail according to a preferred embodiment.

FIG. 1 shows a closure in a perspective view from below;

FIG. 2 shows the closure according to FIG. 1 in a top view;

FIG. 3 shows a cross cut along line DD of the closure according to FIG. 2;

FIG. 4 shows detail E of FIG. 3 in a magnified manner;

FIG. 5 shows a process for making a closure according to the present invention.

### DETAILED DESCRIPTION OF PREFERRED EMBODIMENTS

Corresponding features of the several shown embodiments do in general and if not indicated otherwise have corresponding reference numbers.

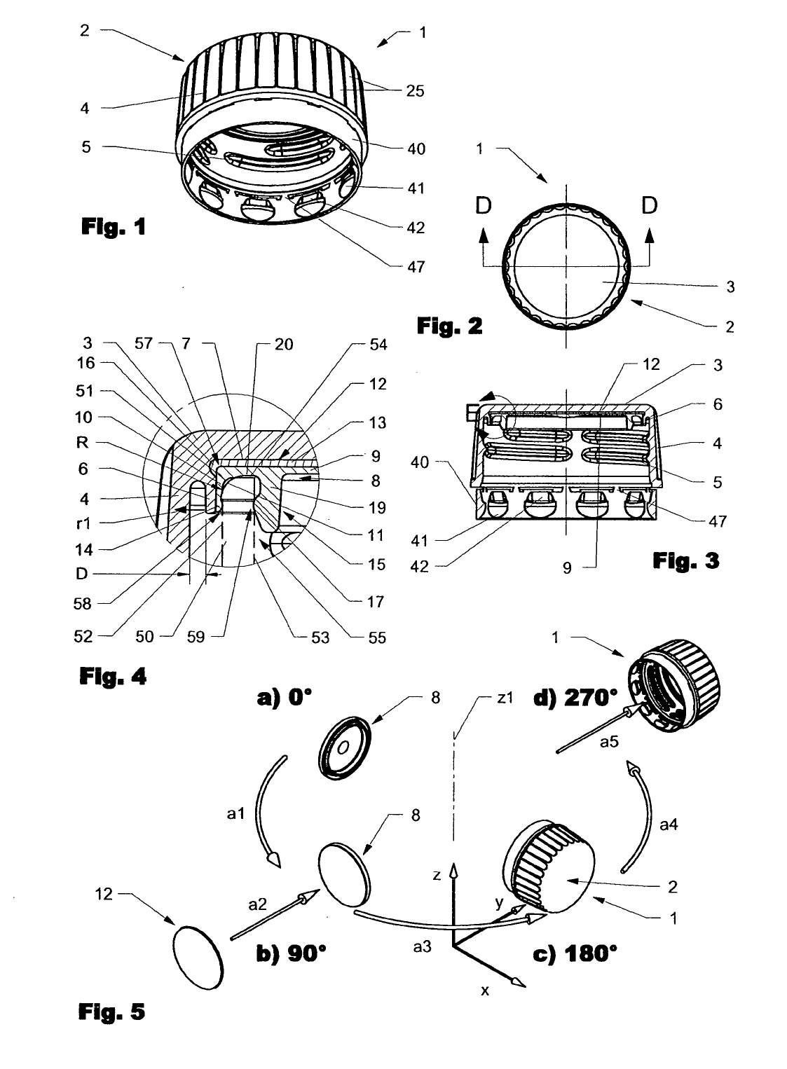

FIG. 1 shows a closure 1 according to the present invention in a perspective view and FIG. 2 shows the same closure in a top view. FIG. 3 shows a cross cut through the closure along line DD of FIG. 2. FIG. 4 shows detail E of FIG. 3 and FIG. 5 schematically visualizes a process for making of a closure 1 according to the present invention.

The setup of a closure 1 according to the present invention is now explained in more detail with reference to FIGS. 1 through 4.

As it can be best seen in FIGS. 1, 3 and 4, an outer shell 2 of closure 1 here comprises a disc like top portion 3, an outer skirt 4 with an internal thread 5 and a ring-shaped inner skirt 6 which is arranged essentially concentrically to the outer skirt 4 at a distance D extending perpendicular from an inner surface 7 of the top portion 3. The outer skirt 4 comprises on the outside knurls 25 which allow easily gripping and turning of the closure 1 while opening. The shown closure 1 further comprises a sealing-liner 8 with a liner disc 9, which extends along the inner surface 7 of the top portion 3 and blends into a downward leg 10 which extends downwardly along the inner skirt 6 and is supported by that.

A barrier liner 12 is arranged in the shown embodiment between and fully surrounded by the outer shell 2 and the sealing liner 8, effectively preventing gas permeation through the closure 1 in the critical areas. The barrier liner 12 as shown comprises a single layer setup and is here made by an injection molding process in the same mold as the closure or outside. Depending on the field of application and the design of the closure it may also have a multilayer setup. In the shown example the barrier liner 12 is made in the same process as the rest of the closure by injection molding a barrier liner material into a cavity. Alternatively or in addition it is possible to insert an e.g. punched-out disc of barrier liner or a barrier liner which was made by a separate injection or compression molding process. If necessary the barrier liner 12 may contain means to temporarily attach and position the barrier liner 12 with respect to the sealing liner 8 such that it can be hold in position for further processing. The barrier liner is made out of or comprises a barrier liner material such as poly-vinylidene chloride (PVDC)

The outer shell 2 of the closure 1 is preferably made out of an outer shell material such as Poly-propylene (PP) or High Density Polyethylene (HDPE). In comparison to the outer shell 2 the sealing liner 8 is preferably formed out of a softer material. Depending on the field of application it is, due to the type of process by which the closure is preferably made, possible to make the outer shell 2 and the sealing liner 8 out of the same material such as PP or PE or one or several other appropriate materials or a combination thereof.

In the area where the outer shell 2 and the sealing liner 8 are in direct contact to each other, the materials are preferably firmly bonded to each other completely enclosing and holding the barrier liner 12. As it can be seen in FIG. 4 the barrier liner 12 has here a three-dimensional shape and blends at its outer rim into an annular bead 16 which clasps around sealing liner 8 such that the barrier liner 12 holds during making of the closure 1 onto the sealing liner 8 even when the material of the sealing liner 8 and the barrier liner 12 are not joinable to each other. The bead 16 further reduces the area not covered by the barrier liner 12 and the distance between the barrier liner 12 and the neck 50 of the container. If desired the barrier liner 12 may extend further down the inner skirt 6 and or being in direct contact with the neck of the container. It may form a mechanical connection e.g. by engaging with an appropriate undercut of the sealing liner 8 to provide better holding. Alternatively or in addition other means may be foreseen which simplify the assembly of the closure. E.g. the barrier liner 12 and sealing liner 8 may be interconnected by vacuum and/or a bonding coating and/or adhesive aids.

The functionality of the sealing liner 8 is now described in more detail. Although the combination of the herein described barrier liner 12 and the sealing liner 8 result in an improved closure, it would be, depending on the field of application, possible to use sealing means which are different shaped. However, it has to be taken care that the sealing means allow the assembly of the closure in the foreseen process, e.g. in that the sealing means temporarily holds onto a core such that the closure can be assembled.

As visible in FIG. 4 a blend 11 between downward leg 10 and the liner disc 9 of the herein shown embodiment comprises a radius R which in the described embodiment sealingly interacts in a closing position of the closure 1 by a first contact point 57 with an outer in general toroidal surface 51 which interconnects an outer cylindrical surface 52 and an annular top surface 54 of a container neck 50 (schematically indicated in FIG. 4 by dash line 50). The downward leg 10 of the sealing liner 8 comprises at its lower free end a first annular sealing ring 14 which protrudes radially inwardly and interacts in the closing position with an outer cylindrical surface 52 of the neck 50 from the outside, forming a second contact point 58 located at a certain distance from the annular top surface 54. The toroidal sealing ring 14 and the inner skirt 6 are shown in an undeformed manner but will be extended radially outwardly in the direction of arrow r1 during application onto a neck 50 of a container. Depending on the field of application, the design of gap 24 is chosen such that no interaction takes place between the inner skirt 6 and the outer skirt 4 of the closure 1.

The sealing liner 8 further comprises a bore seal 15 which extends downwardly into an opening 55 of the neck 50 as a second downward leg. The bore seal 15 comprises here a second annular sealing ring 17 protruding radially outwardly interacting in a closed position by a third contact point 59 with the inner surface 53 of neck 50. The sealing liner 8 is preferably made of a softer material with respect to the outer shell 2 of the closure 1 and the neck 50 such that it wraps around the neck of the bottle forming tight contact and sealing in the designated areas. Depending on the field of application the sealing liner 8 may be made out of the same material as the outer shell 2 of the closure 1. The second annular sealing ring 17 is shown in an undeformed manner but will be deformed radially inwardly during application onto neck 50. In the shown embodiment the bore seal 15 comprises an in general vertically arranged base area 19 on its outside between the liner disc 9 and the second annular sealing ring 17. If appropriate an intermediate top surface 20 comprises an in general v-shaped protrusion (not shown here) which forms a top seal and interacts in the closing position with the annular top surface 54 of neck 50.

As it can be seen the first and the second annular sealing ring 14, 17 are forming radially arranged undercuts, directed to the neck 50 of the container, which are under normal conditions difficult to take out of the mold. It has been shown that the design of the downward leg 10 and the bore seal 15 can be demoulded without any drawback by the process described herein. In a further embodiment the outer downward leg 10 and the inner downward leg 15 are arranged at an angle to the top portion 3 having an in general conical shape with an in general parallel and/or decreasing radial thickness in the direction of their lower free end. This second embodiment provides simpler demoulding with certain materials. The inner downward leg 15 may be arranged extending from its base on radially outwardly forming a contact point for interaction with the inner surface of the neck 50. By the choice of an appropriate soft material the inner downward leg 15 is deformed due to inner pressure, acting on the inside of the downward leg 15, radially outwardly supporting the sealing performance in relation to the inner pressure.

During making of the closure 1 by a multi-component injection molding process the sealing liner 8 is normally made first in that liquid sealing liner material is injected into a cavity onto a core of the injection molding device where the material congeals. The core (not visible) corresponds at least partially to the inside of the liner disc 8 and the bore seal 15 and/or the downward leg 10. The downward leg 10 and/or the bore seal 15 act as temporary holding means and encompass during the making of the closure 1 at least partially the core and guarantee that the sealing liner 8 temporarily sufficiently holds onto the core such that the sealing liner 8 can be moved with the core between the several process steps necessary to making of the closure 1.

As it can be seen in FIGS. 1 and 3 the described closure 1 comprises a tamper band 40 with undercut segments 41 protruding radially inwardly. Above the undercut segments 40 centring elements 42 are arranged which are here in general aligned to the closure axis z and which help to centre the closure 1 with respect to a locking bead (not shown in detail) of the neck 50 of a container. The radial extension of the centring elements 42 is decreasing in the direction of the disc like top portion 3 and their lateral cross-section (cross-section perpendicular to the axis z of the closure 1) is suitable to receive the undercut segments 41 during ejection of the closure 1 out of the mold. The centring elements 42 are therefore not only coaxially positioning the tamper band 40 with respect to the neck 50 but also work as a ramp during ejection out of the mold. The tamper band 40 is interconnected to the outer skirt 3 by tearable bridges 47. Although the herein shown design of a tamper band 40 results in improved performance, alternative designs are possible.

FIG. 5 is schematically displaying a process to make a closure 1 according to the present invention. In a first position, here at position a) (0°), a sealing liner 8 is made by injecting liquid sealing liner material into a cavity and onto a core (both not shown in detail) of an injection molding device or mold where the liquid sealing liner material congeals. The sealing liner 8 encompasses the core at least partially such that the sealing liner 8 sufficiently holds onto the core during making of the closure and moving into several positions. After that the sealing liner material is sufficiently solid, the injection molding device is opened and the sealing liner 8 is rotated together with its core, as indicated by arrow a1, around a rotation axis z1 into position b), here at 90° with respect to position a). In position b) a barrier liner 12 is, as schematically indicated by arrow a2, applied onto the sealing liner 8. Depending on the design of the process the barrier liner 12 is pre-made and then attached to the sealing liner 8 which is still positioned on a core or the barrier liner 12 is made by injecting liquid barrier liner material into a cavity wherefrom the sealing liner 8 is forming at least part of the cavity wall. To guarantee a sufficient holding of the barrier liner 12 on the sealing liner 8 the barrier liner 12 and the sealing liner 8 may interlock to each other by interlocking means or other facilities. Afterwards the assembled sealing liner 8 and the barrier liner 12 are rotated together, as indicated by arrow a3, around axis z into further position c) at 180° with respect to position a). In position c) liquid plastic material is injected into a further cavity to form the outer shell 2 of the closure 1. The sealing liner 8 and/or the barrier liner 12, which are forming part of the cavity to form the outer shell 2, are thereby bond or mechanically interconnected to the outer shell 2 of the closure 1. After the outer shell 2 of the closure 1 is sufficiently solid the injection molding device is opened and the closure 1 is removed from the injection molding device. In the shown embodiment the closure 1 is therefore moved by rotation around axis z into position d) at 270° where it is ejected. The movement between the single stations allows sufficient cooling.

The closure 1 as here described is preferably made by a stack mold turning system as available on the marked. Such a stack mold turning system in general comprises a fixed and a movable mold half, which is arranged displaceable along tie bars with respect to the fixed mold halve, and a cubical middle part arranged rotatable around an rotation axis z1 arranged perpendicular to the tie bars. The cubical middle, which normally has four side faces with cores suitable to receive and temporarily encompass at least partially with sealing liners, is also movable in direction of the tie bars at half the speed of the movable mold half. The stack mold turning system can be opened and closed along a first and a second mold separation plane arranged between the fixed mold halve and the cubical middle part and the cubical middle part and the movable mold half. Between the molding cycles the stack mold turning system is opened such that the cubical middle part can be rotated around the ration axis. With respect to the above explained process the position a) at 0° and c) at 180° are arranged between the fixed mold halve and the cubical middle part and the cubical middle part and the movable mold half. The positions c) at 90° and d) at 270° are accessible from lateral sides of the injection molding device. The barrier liner is applied to the sealing liner either by appropriate handling systems such as a robot or by an injection molding device arranged at 90°. By the described injection molding device it is possible to make at the same time a sealing liner at position a), a barrier liner at position b) and an outer shell at position c). In between each cycle the injection molding device is opened and the cubical middle part when open turned by stepwise by 90°. After that the injection molding device is closed again and the next cycle takes place. By this it is possible to make a closure according to the present invention very efficiently.

1. A closure (1) comprising:
an outer shell (2) and a sealing liner (8);
a barrier liner (12) at least partially encompassed by the sealing liner (8) and the outer shell (2), and
wherein the sealing liner (8) comprises holding means (10, 15) to temporarily hold onto a core of an injection molding device such that the sealing liner (8) can be moved between several positions during making of the closure (1).

2. The closure (1) according to claim 1, further comprising:
at least one of mechanical means (16), vacuum and adhesive to attach the barrier liner (12) to the sealing liner (8) during making of the closure (1).

3. The closure (1) according to claim 1 wherein the barrier liner (12) has a 3-dimensional shape which partially encompasses the sealing liner (8).

4. The closure (1) according to claim 3, wherein the barrier liner (12) includes an annular protrusion (16).

5. The closure (1) according to claim 1 wherein the barrier liner (12) is fully encompassed by the outer shell (2) and the sealing liner (8).

6. The closure (1) according to claim 1 wherein the sealing liner (8) comprises at least one downward leg (10, 15).

7. The closure (1) according to claim 6, wherein the downward leg acts as a holding means during making of the closure (1).

8. The closure (1) according to claim 6 wherein the at least one downward leg (10, 15) is an outside seal (10).

9. The closure (1) according to claim 8, wherein the outside seal (10) comprises an annular sealing ring (14) forming in a closed position a first contact point with an outer cylindrical surface (52) of a neck (50).

10. The closure (1) according to claim 8 wherein the outside seal (10) blends by a blend (11) having a radius R into a liner disc (9), whereby said blend (11) forms in a closed position a second contact point with an outer top surface (51) of the neck (50).

11. The closure (1) according to claim 8 wherein the outside seal (10) is laterally supported by an inner skirt (6) of the outer shell (2).

12. The closure (1) according to claim 11 wherein the inner skirt (6) is arranged generally concentrically to the outer skirt (4) at a distance D.

13. The closure (1) according to claim 12, wherein the inner skirt (6) extends perpendicular from the inner surface (7) of the top portion (3).

14. The closure (1) according to claim 6 wherein the sealing liner (8) comprises a downward leg in form of a bore seal (15) which forms a further contact point with an inner surface (53) of the neck (50).

15. The closure (1) according to claim 1 wherein the outer shell (2) and the sealing liner (8) are made out of a different material or a same material.

16. A process for making a closure (1) according to claim 1 comprising the following steps:
a) injecting a liquid sealing liner material into a cavity of an injection molding device onto a core where the sealing liner material congeals forming a sealing liner (8);
b) attaching a barrier liner (12) onto the sealing liner (8);
c) injecting a liquid shell material into a cavity around the barrier liner (8) and the sealing liner (12) forming an outer shell (2) of the closure (1).

17. The process according to claim 16, wherein the barrier liner (12) is made separately outside the injection molding device and attached to the sealing liner (8) by a handling system.

18. The process according to claim 16, wherein the barrier liner (12) is made in the injection molding device in that liquid barrier liner material is injected into a cavity whereby the sealing liner is forming part of the cavity wall.

19. The process according to claim 18, wherein the barrier liner material (12) encompasses the sealing liner (8) during injection.

20. The process according to claim 16, wherein the sealing liner (8) is made in an injection molding device in a first position (a) at 0°, the barrier liner (12) is attached in a second position (b) at 90° and the shell of the closure is made in a third position (c) at 180°.

21. The process according to claim 20, wherein the closure is retrieved from the injection molding device at the third position (c) at 180° or in a fourth position (d) at 270°.

22. A closure (1) comprising:
an outer shell (2);
a sealing liner (8) including at least one downward leg (10, 15) forming an outside seal (10) wherein the at least one downward leg (10, 15) temporarily holds onto a core of an injection molding device such that the sealing liner (8) can be moved between several positions during making of the closure (1); and
a barrier liner (12) that includes an annular protrusion (16) wherein the barrier liner (12) is at least partially encompassed by the sealing liner (8) and the outer shell (2).
